(19) United States
(12) Patent Application Publication
(10) Pub. No.: US 2008/0183495 A1
(43) Pub. Date: Jul. 31, 2008

(54) ECONOMICALLY SUSTAINABLE, STANDARDS-BASED RHIO ARCHITECTURE AND APPLICATION ENVIRONMENT AND METHOD OF USE

(76) Inventors: Nathaniel Blair Butterfield, Shelbourne, VT (US); George B. Langdon, Shelbourne, VT (US); Michael Ian Lieberman, Portland, OR (US); Thomas Nicholas Ricciardi, Portland, OR (US); Mandred A. Gund, Beaverton (OR); William Louis Howard, Charlotte, VT (US); Anthony Perrigo Brown, Cholchester, VT (US); Douglas Gustav Spilling, Elizabethtown, NY (US); Michael F. Joseph, Milton, VT (US); Marianne Noel Braunstein, Portland, OR (US); Milan Caha, Essex, VT (US)

Correspondence Address: MCANDREWS HELD & MALLOY, LTD, 500 WEST MADISON STREET, SUITE 3400, CHICAGO, IL, 60661, US

(21) Appl. No.: 11/753,976

(22) Filed: May 25, 2007

Related U.S. Application Data
(60) Provisional application No. 60/886,590, filed on Jan. 25, 2007.

(51) Int. Cl. G06Q 50/00; G06F 3/048

(52) U.S. Cl. 705/2; 715/742

(57) ABSTRACT

Certain embodiments provide systems and methods for health information exchange. Certain embodiments provide a health information exchange system. The system includes an interface accommodating a plurality of data sources transmitting data for storage at the health information exchange system. The system also includes a shared data repository configured to aggregate and store patient-related data from the plurality of data sources. The shared data repository is accessible to a community of users via the health information exchange system. The system further includes a query engine for querying the shared data repository to retrieve a subset of patient-related data. Additionally, the system includes a Web-based portal providing an authorized user access to the subset of patient-related data for at least one of patient care and clinical performance.

### RELATED APPLICATIONS

This application claims priority to a provisional application filed on Jan. 25, 2007, as Ser. No. 60/886,590, which is herein incorporated by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention generally relates to a healthcare information architecture and application environment. More particularly, the present invention relates to an economically sustainable, standards-based healthcare information architecture and application environment.

Hospitals typically utilize computer systems to manage the various departments within a hospital and data about each patient is collected by a variety of computer systems. For example, a patient may be admitted to the hospital for a Transthoracic Echo (TTE). Information about the patient (e.g., demographics and insurance) could be obtained by the hospital information system (HIS) and stored on a patient record. This information could then be passed to the cardiology department system (commonly known as the cardio vascular information system, or CVIS), for example. Typically the CVIS is a product of one company, while the HIS is the product of another company. As a result, the database between the two may be different. Further, information systems may capture/retain and send different levels of granularity in the data. Once the patient information has been received by the CVIS, the patient may be scheduled for a TTE in the echo lab. Next, the TTE is performed by the sonographer. Images and measurements are taken and sent to the CVIS server. The reading physician (e.g., an echocardiographer) sits down at a review station and pulls the patient's TTE study. The echocardiographer then begins to review the images and measurements and creates a complete medical report on the study. When the echocardiographer completes the medical report, the report is sent to the CVIS server where it is stored and associated with the patient through patient identification data. This completed medical report is an example of the kind of report that could be sent to a data repository for public data mining. Medication instructions, such as documentation and/or prescription, as well as laboratory results and/or vital signs, may also be generated electronically and saved in a data repository.

Today, medical device manufacturers and drug companies face an ever-growing challenge in collecting clinical data on the real-life utilization of their products. As patient medical reports are becoming computerized, the ability to obtain real-life utilization data becomes easier. Further, the data is easier to combine and analyze (e.g., mine) for greater amounts of useful information.

As medical technology becomes more sophisticated, clinical analysis may also become more sophisticated. Increasing amounts of data are generated and archived electronically. With the advent of clinical information systems, a patient's history may be available at a touch of a button. While accessibility of information is advantageous, time is a scarce commodity in a clinical setting. To realize a full benefit of medical technological growth, it would be highly desirable for clinical information to be organized and standardized.

Even if clinical or image-related information is organized, current systems often organize data in a format determined by developers that is unusable by one or more medical practitioners in the field. Additionally, information may be stored in a format that does not lend itself to data retrieval and usage in other contexts. Thus, a need exists to structure data and instructions in a way that is easier to comprehend and utilize.

Data warehousing methods have been used to aggregate, clean, stage, report and analyze patient information derived from medical claims billing and electronic medical records (EMR). Patient data may be extracted from multiple EMR databases located at patient care provider (PCP) sites in geographically dispersed locations, then transported and stored in a centrally located data warehouse. The central data warehouse may be a source of information for population-based profile reports of physician productivity, preventative care, disease-management statistics and research on clinical outcomes. Patient data is sensitive and confidential, and therefore, specific identifying information must be removed prior to transporting it from a PCP site to a central data warehouse. This removal of identifying information must be performed per the federal Health Insurance Portability and Accountability Act (HIPAA) regulations. Any data that is contained in a public database must not reveal the identity of the individual patients whose medical information is contained in the database. Because of this requirement, any information contained on a medical report or record that could aid in tracing back to a particular individual must be removed from the report or record prior to adding the data to a data warehouse for public data mining.

Patient data may be useful to medical advancement, as well as diagnosis and treatment of patients, in a variety of ways. In order to accurately assess the impact of a particular drug or treatment on a patient, for example, it is helpful to analyze all medical reports relating to the particular patient. Removing data that can be used to trace back to an individual patient can make it impossible to group and analyze all medical reports relating to a particular patient. In addition, one of the aims of population analysis is to assemble an at-risk cohort population comprised of individuals who may be candidates for clinical intervention. De-identified data is not very useful to the patient care providers who need to know the identity of their own patients in order to treat them. Users of the system may need the ability to re-identify patients for further follow-up. Portal users may need to re-identify the patients in a process that doesn't involve the portal system, i.e. the process of re-identification occurs on the local user's system.

Increasing numbers of medical information systems require free text search capability for searching finding information about a specific medical diagnosis, patient demographics, decease statistics, etc. Current search engines such as Google, MSN, Yahoo, etc., provide free text search capability with web sites and do not provide such search capability within an enterprise. Additionally, these search engines are not customized for searching electronic medical records.

Efforts are underway nationally to connect healthcare information systems and make them interoperable in a secure, sustainable, and standards-based manner. However, the required information infrastructure is still under development, both for the National Health Information Network (NHIN) led by the federal government, as well as for the many small Regional Health Information Organizations (RHIOs) across the nation. Many challenges remain for health information exchange in the United States and elsewhere. For example, financial sustainability models must be determined for construction and operation of NHINs and RHIOs. Additionally, there is a need for standardization and interoperability of healthcare information among participants in exchange networks. Furthermore, there is a need for systems providing centralization versus distributed data architectures.

Systems providing an aggregated, complete, patient-centric view of health information would be highly desirable. There is a need to create large databases of de-identified population data for quality improvement, care management, and research, for example. Additionally, there is a need for governance, patient and provider control of information access, privacy, and security.

Therefore, there is a need for systems and methods interconnecting healthcare information systems to provide secure, interoperable and sustainable exchange of patient data for quality improvement, care management and research, among other things. There is a need for an economically sustainable, standards-based healthcare information architecture and application environment.

### BRIEF SUMMARY OF THE INVENTION

Certain embodiments provide systems and methods for health information exchange.

Certain embodiments provide a health information exchange system. The system includes an interface accommodating a plurality of data sources transmitting data for storage at the health information exchange system. The system also includes a shared data repository configured to aggregate and store patient-related data from the plurality of data sources. The shared data repository is accessible to a community of users via the health information exchange system. The system further includes a query engine for querying the shared data repository to retrieve a subset of patient-related data. Additionally, the system includes a Web-based portal providing an authorized user access to the subset of patient-related data for at least one of patient care and clinical performance.

Certain embodiments provide a method for providing health information exchange services. The method includes providing, for a fee, an interface allowing a plurality of data sources to transmit data to one or more shared data repositories accessible to participants in a health information exchange. The method also includes providing, for a fee, population data from the one or more shared data repositories based on a query.

Certain embodiments provide a health information exchange. The exchange includes pre-established data connectivity for import and export of patient data to be shared for a region. The exchange also includes an electronic medical record database configured to aggregate, scrub, structure and transform raw clinical data for the region. The exchange further includes a population data warehouse loaded with data from the electronic medical record database for data extraction for clinical quality and clinical outcomes reporting.

### BRIEF DESCRIPTION OF SEVERAL VIEWS OF THE DRAWINGS

FIG. 1 illustrates a health information exchange (HIE) in accordance with an embodiment of the present invention.

FIG. 2 illustrates a medical quality improvement consortium (MQIC) facilitated using a HIE in accordance with an embodiment of the present invention.

FIG. 3 shows an exemplary Web-based portal used in accordance with an embodiment of the present invention.

FIG. 4 illustrates a health information architecture in accordance with an embodiment of the present invention.

FIG. 5 illustrates a health information architecture in accordance with an embodiment of the present invention.

FIG. 6 illustrates a population reporting and research architecture in accordance with an embodiment of the present invention.

FIG. 7 illustrates a flow diagram for a method for providing health information exchange services in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

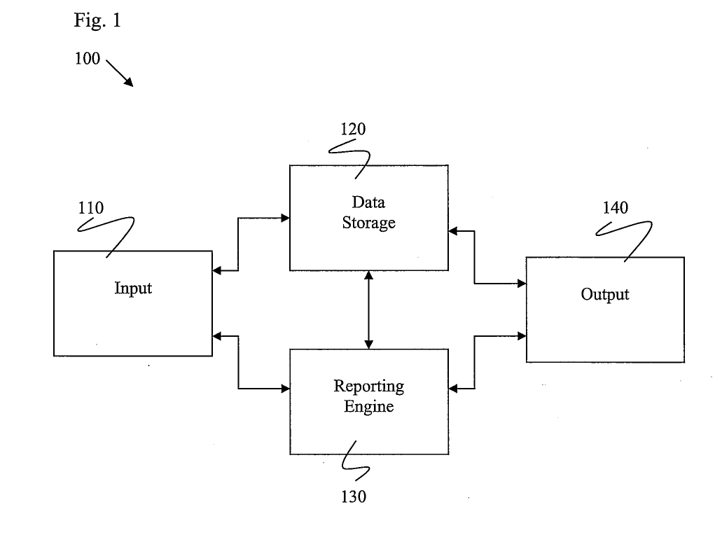

FIG. 1 illustrates a health information exchange (HIE) 100 in accordance with an embodiment of the present invention. The HIE 100 is organized to provide storage, access and searchability of healthcare information across a plurality of organizations. The HIE 100 may service a community, a region, a nation, a group of related healthcare institutions, etc. For example, the HIE 100 may be implemented as and/or implemented with a regional health information organization (RHIO), national health information network (NHIN), medical quality improvement consortium (MQIC), etc. In certain embodiments, the HIE 100 connects healthcare information systems and helps make them interoperable in a secure, sustainable, and standards-based manner.

The HIE 100 provides a capability to exchange information between both related and disparate healthcare information systems. The HIE 100 helps facilitate access to and retrieval of clinical and other healthcare data with improved safety, timeliness and/or efficiency, etc. Components and/or participants in the HIE 100 adhere to a common set of principles and standards for information sharing within a provided technical infrastructure, for example. The HIE 100 may be used to store, access and/or retrieve a variety of data, including data related to outpatient and/or inpatient visits, laboratory results data, emergency department visit data, medications, allergies, pathology results data, enrollment and/or eligibility data, disease and/or chronic care management data/services, etc.

In certain embodiments, the HIE 100 helps to provide financial sustainability models for construction and operation of NHINs and/or RHIOs. In certain embodiments, the HIE 100 helps facilitate standardization and interoperability of healthcare information among participants in exchange network(s). In certain embodiments, the HIE 100 provides a centralized data architecture. However, in certain embodiments, the HIE 100 may also utilize a combined centralized yet partially distributed data architecture. Certain embodiments create an aggregated, patient-centric view of health information. In certain embodiments, the HIE 100 provides one or more large databases of de-identified population data for quality improvement, care management, research, etc. Through the HIE 100, a patient and/or provider may control information access, privacy, and security, for example.

The HIE 100 includes one or more inputs 110, a data storage 120, a reporting engine 130 and one or more outputs 140. In certain embodiments, the data storage 120 is a centralized data storage and/or may be subdivided in to a plurality of interconnected data storage. The reporting engine 130 may be used to generate queries, searches and/or other reports based on data in the data storage 120 and one or more requests, parameters, criteria, etc., specified by the input 110 and/or preset in the HIE 100, for example. The one or more inputs 110 may include a variety of informational and/or query sources, such as healthcare facilities, labs, electronic medical record (EMR) systems, healthcare information systems, insurance systems, pharmaceutical systems, etc. The one or more outputs 140 may include one or more web viewers or portals, EMR systems, application service provider (ASP) systems, healthcare information systems, practice management systems, etc. The components of the HIE 100 may be implemented individually and/or in various combinations in software, hardware and/or firmware, for example.

In certain embodiments, the HIE 100 provides a technical architecture, web applications, a data repository including EMR capability and a population-based clinical quality reporting system, for example. The architecture includes components for document storage, such as the data storage 120, querying, such as the reporting engine 130, and connectivity to data sources, such as input 110 and output 140. The output 140 may include web portal applications for data presentation to physicians and patients, for example. In certain embodiments, the data repository 120 may include an option for a subscription-based EMR for physicians, for example. In certain embodiments, the HIE 100 provides a population-based clinical quality improvement and research database with reporting tools, for example.

In certain embodiments, a financial sustainability model governs these capabilities. Through ASP provision, leasing, licensing, etc., the HIE 100 can generate revenue for data access and storage, for example. The system 100 allows an EMR to be licensed/leased to physicians who do not have an EMR. Thus, physicians may use only minimal information technology (IT) administration to access the EMR. Additionally, the ASP-provided EMR from the HIE 100 includes built-in connectivity to regional data sources and an automated quality/research reporting capability of the data warehouse to which the centralized EMR is connected. Furthermore, using an EMR with ASP access, new technology may be rolled out or distributed regionally and/or otherwise to a physician office, for example.

Using the cross document sharing or XDS standard, for example, in the HIE 100, document querying and storage can be integrated for more efficient and uniform information exchange. Using the HIE 100, quality reporting and research may be integrated in and/or with an RHIO and/or other environment. The HIE 100 provides a single-vendor integrated system that can integrate and adapt to other standards-based systems, for example. The HIE 100 allows a provider to package both existing and new products and/or services for the RHIO and/or other market.

As mentioned above, in certain embodiments, the HIE 100 provides a financial sustainability to a healthcare organization, such as an RHIO. Using EMR application services via the HIE 100, an RHIO can generate revenue streams, for example. Alternatively and/or in addition, use of population-based data from the HIE 100 may be used to create revenue streams for the RHIO, for example.

In certain embodiments, the HIE 100 helps to facilitate the implementation of an MQIC. Via the HIE 100, a group of EMR users may agree to pool data at the data storage 120. The HIE 100 may then provide the group with access to aggregated data for research, best practices for patient diagnosis and treatment, quality improvement tools, etc. Royalties for the use of data may be generated as compensation, for example. Through the MQIC and the HIE 100, users may help to improve the quality of healthcare through updated tools and expanded EMR quality improvement reports, for example. The MQIC and the HIE 100 offer members updated clinical information regarding patient illnesses, such as diabetes, heart attack, stroke, hypertension, congestive heart failure, and the like. Data exchange may also be used for clinical research. In certain embodiments, user may opt in or out of particular projects/collaborations via the HIE 100.

In certain embodiments, a secure Internet line and/or Web-based portal may be used to access the HIE 100 to participate in a MQIC. In certain embodiments, the HIE 100 extracts clinical-level patient data on a regular basis (e.g., nightly) from participating EMRs 110 to a centralized data warehouse or other data storage 120. The reporting engine 130 re-formats the data into useful reports in order for physicians and practices to benchmark their performances against a national, regional and/or other database, for example. In certain embodiments, data collected is HIPAA-compliant with patient-identifying information removed such that only relevant EMR customers can re-identify individual patients. Examples of de-identifying and/or re-identifying patient data may be found in U.S. Patent Application Publication No. 20040215981, entitled “Method, System and Computer Product for Securing Patient Identity,” by Ricciardi et al., and U.S. patent application Ser. No. 11/469,747, entitled “Systems and Methods for Patient Re-Identification,” by Cookson et al., which are herein incorporated by reference in their entirety. Participating physicians using the HIE 100 can privately run automated population-based reports via a simple Web-based portal, analyzing data from physician office EMR(s). Generated report(s) give physicians assistance to gauge whether their patients are receiving recommended care. Using the local EMR and the HIE 100, physicians and clinical staff may document patient encounters electronically, help to streamline clinical workflow and more securely exchange data with other providers, payors and information systems. Decision support tools may also help inform physicians of harmful drug interactions based on automated medication checking and reminders for tests and/or procedures to help facilitate proactive management of patient health. Using the information and tools provided by the HIE 100, physicians may be enabled to improve process and quality of care, measure clinical performance and/or increase reimbursement for services, for example.

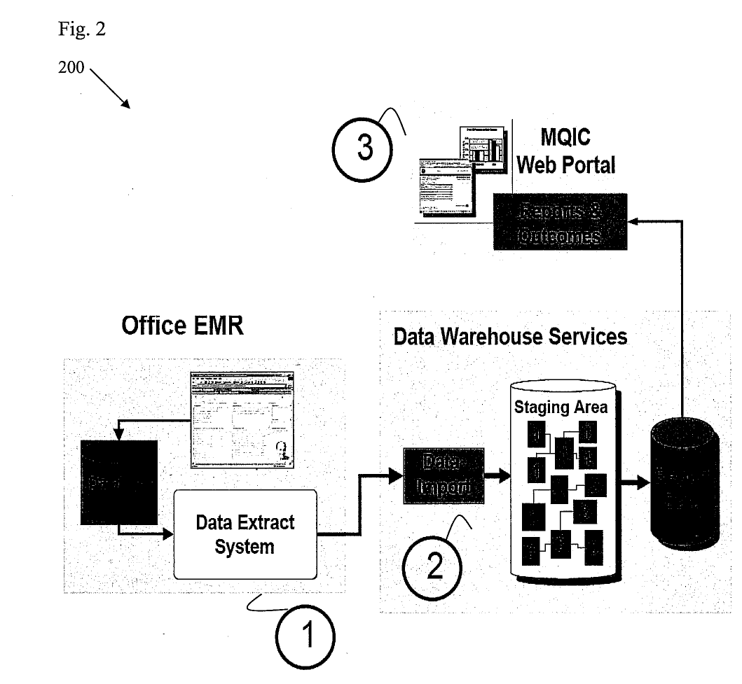

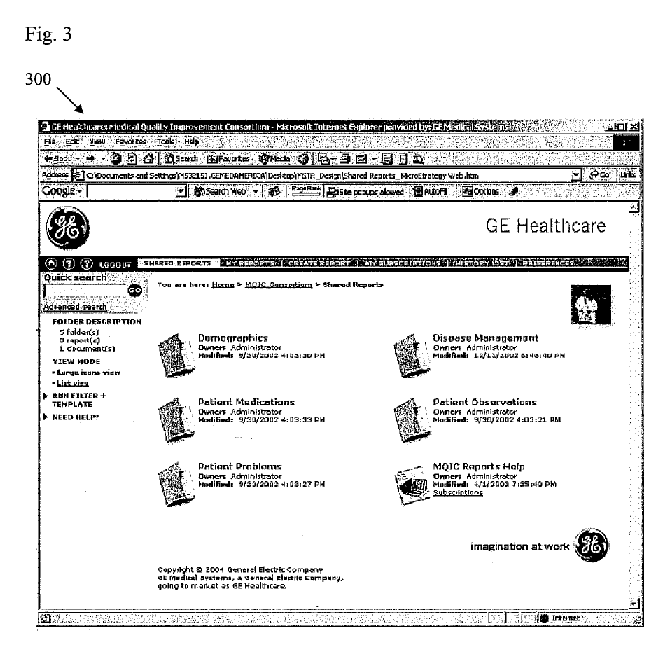

As illustrated in FIG. 2, the HIE 100 may facilitate an MQIC through the extraction of data from one or more local EMRs, the importation and aggregation of the data in a data warehouse, and the generation of reports available to participants via a web portal or EMR. At step 1, data input into a local EMR database is extracted. At step 2, the extracted data is imported, aggregated and/or otherwise analyzed, and used in generating report data. For example, data may be “cleaned” or normalized to a common grammar or format. Examples of scrubbed or normalized data may be found in U.S. Patent Application Publication No. 20060235881, entitled “System and Method for Parsing Medical Data,” by Fred Masarie et al., which is herein incorporated by reference in its entirety. At step 3, reports and/or other outcomes are provided to participating users via a Web portal. An example of a Web-based portal 300 is shown in FIG. 3. A variety of information, tools and/or other assistance may be offered via the portal 300. The components shown in FIGS. 2 and 3 may be implemented individually and/or in various combinations in software, hardware and/or firmware, for example.

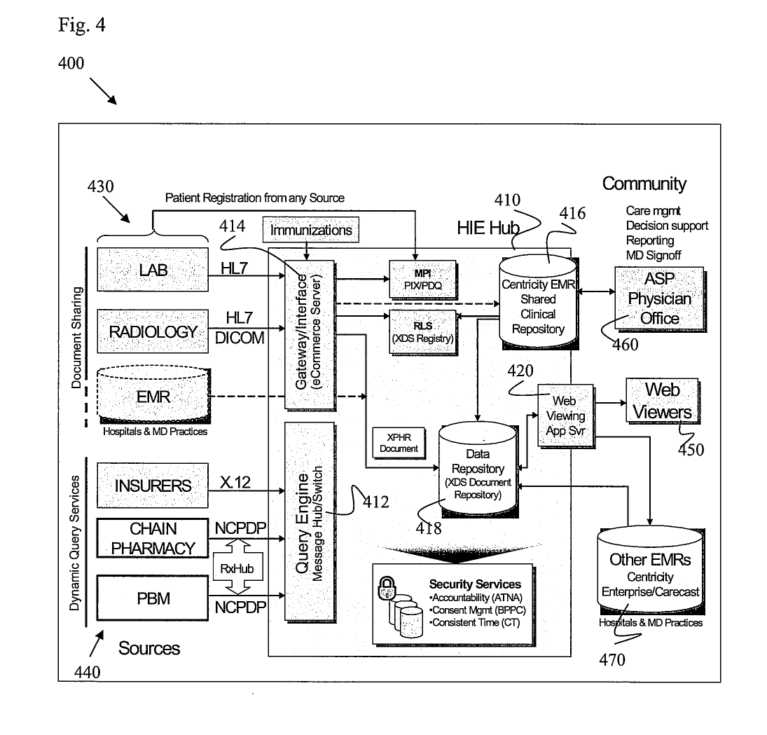

FIG. 4 illustrates a health information architecture 400 in accordance with an embodiment of the present invention. The architecture 400 includes an HIE hub 410, one or more data sharing sources 430, one or more data query sources 440, one or more Web viewers 450, a physician office ASP 460 and one or more EMRs 470. The HIE hub 410 may include a plurality of subcomponents, such as a query engine 412, a gateway or interface 414, an EMR shared clinical repository 416, a data repository 418 and a Web viewing application server 420. The hub 410 may also provide security services for the storage, retrieval and query of data, for example. Data source(s) 430 may include EMR, radiology, laboratory and/or other clinical data sources, for example. Data query source(s) 440 may include insurers, pharmacies, prescription benefit managers, and/or other services, for example. The components of the health information architecture 400 may be implemented individually and/or in various combinations in software, hardware and/or firmware, for example.

In operation, document sharing may be facilitated by the architecture 400 via the hub 410. Patient data is passed from one or more sources 420 using an interface standard, such as the standards approved by the Health Information Technology Standards Panel (HITSP) and accepted by the US Department of Health and Human Services (HHS), Health Level Seven (HL7) and/or Digital Imaging and Communications in Medicine (DICOM) communication interface and file format standards. Data enters the hub 410 via the gateway/interface 414. Within the hub 410, a message passing interface (MPI), including a patient identifier cross-reference (PIX) and/or a patient demographic query (PDQ) may help facilitate exchanging of relevant patient data. Furthermore, a record locator service (RLS) may be used in the hub 410 to help locate appropriate shared documents using a cross-enterprise document sharing (XDS) registry, for example. Clinical data and/or documents may be stored in the EMR shared clinical repository 416 and/or the data repository 418.

One or more query sources 440 may transmit query information to the query engine 412 using an interface standard, such as the X.12 and/or National Council for Prescription Drug Programs (NCPDP) communication standard or standards approved by HITSP and accepted by HHS. The query engine 412 serves as a message hub and/or switch to route query messages to appropriate repository(ies).

In certain embodiments, the data repository 418 includes an XDS document repository populated at least in part by Continuity of Care Documents (CCD) or other clinical summary documents from the Electronic Medical Record (EMR), from any source 430 or 440, or by personal health record (PHR) documents. These documents can be forwarded to users 460 and/or 470, or queried by them. For example, the data repository 418 may include exchanging personal health record (XPHR) content providing common information requested by healthcare providers. Through XPHR, patients may provide a summary of their PHR information to providers, and providers may suggest updates to a patient's PHR after a healthcare encounter.

A community of one or more physician or other healthcare office systems may store, access, or exchange information in the EMR shared clinical repository 416, such as an ASP-based office system 460. For example, information relating to care management, decision support, reporting and/or physician signoff may be utilized. Alternatively and/or in addition, data from the data repository 418 may be exchanged with one or more EMRs 470 (e.g., primary care provider EMRs), for example. Data from the data repository 418 may also and/or alternatively be provided to one or more Web viewers or portals 450 via a Web server or application 420.

In certain embodiments, a Web portal may be used to facilitate access to information, patient care and/or practice management, for example. Information and/or functionality available via the Web portal may include one or more of order entry, laboratory test results review system, patient information, clinical decision support, medication management, scheduling, electronic mail and/or messaging, medical resources, etc.

In certain embodiments, the Web portal serves as a central interface to access information and applications, for example. Data may be viewed through the Web-based portal or viewer, for example. Additionally, data may be manipulated and propagated using the Web portal, for example. Data may be generated, modified, stored and/or used and then communicated to another application or system to be modified, stored and/or used, for example, via the Web portal and HIE hub.

The Web portal may be accessible locally (e.g., in an office) and/or remotely (e.g., via the Internet and/or other private network or connection), for example. The Web portal may be configured to help or guide a user in accessing data and/or functions to facilitate patient care and practice management, for example. In certain embodiments, the Web portal may be configured according to certain rules, preferences and/or functions, for example. For example, a user may customize the Web portal according to particular desires, preferences and/or requirements.

In certain embodiments, an XDS profile and/or protocol (e.g., an Integrating the Healthcare Enterprise Cross-Enterprise Sharing of Medical Summaries Integration Profile (IHE XDS-MS) protocol) may be used to define a coupling or connection between one or more entities for patient document sharing. For example, XDS may be used to form a query identifying sources with information about a particular patient and/or other criteria, determining an identifier used to associate clinical data related to the patient and/or other criteria and request patient information from the appropriate source and/or repository, such as an XDS document repository 418, for example. As discussed above, a record locator service (RLS) may also be used to facilitate sharing of information between organizations.

In certain embodiments, the hub 410 provides security services during transmission and querying of data. Security services may include generation and storage of audit records, such as audit trail and node authentication (ATNA) accountability records. Additionally, security services may include patient privacy consent management, such as basic patient privacy consent (BPPC). Security services may also include coordination or consistency of time (CT) across network systems.

In certain embodiments, the architecture 400 supports trusted intermediaries or actors with in the hub 410 to associate identity and trust among data/service providers and data/service clients. Once a source and/or user have been authenticated, the hub 410 can use the authentication to establish a security context for the data. Patient privacy consent, such as BPPC may provide a profile for access control to data and/or systems, for example. Patient consent is obtained from a patient and establishes rules for sharing and using patient data. Patient privacy consent may combine with authentication, for example, to help ensure reliability and security in the architecture 400. For example, cross-user authentication and patient consent may be used to authenticate sharing of EMR information for a patient between two healthcare entities. A BPPC profile may provide an implementation of privacy consent policies in the architecture 400, and a language or protocol, such as Extensible Access Control Markup Language (XACML), may be used with the BPPC to implement access control rules.

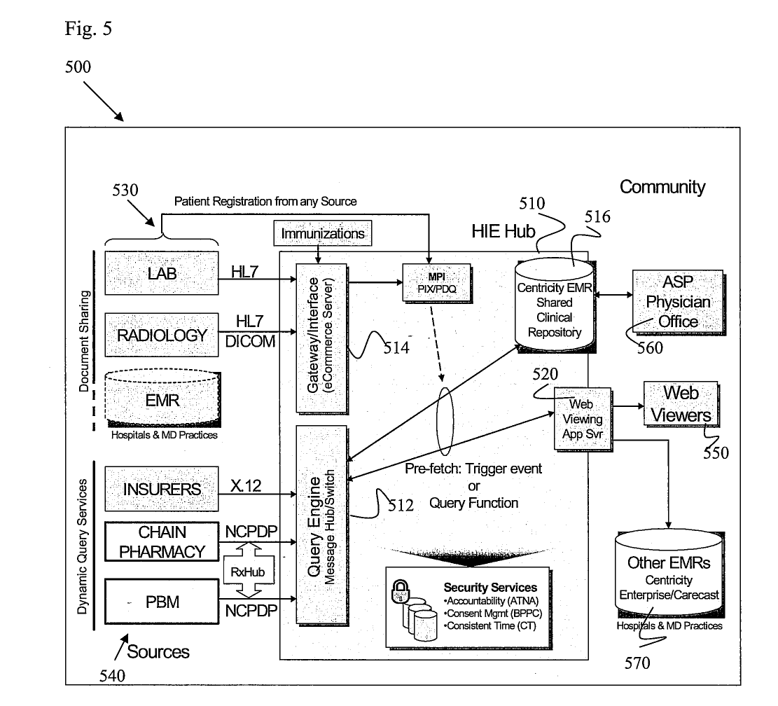

FIG. 5 illustrates a health information architecture 500 in accordance with an embodiment of the present invention. The architecture 500 includes an HIE hub 510, one or more data sharing sources 530, one or more data query sources 540, one or more Web viewers 550, a physician office ASP 560 and one or more EMRs 570. The HIE hub 510 may include a plurality of subcomponents, such as a query engine 512, a gateway/interface 514, an EMR shared clinical repository 516 and a Web viewing application server 520. The hub 510 may also provide security services for the storage, retrieval and query of data, for example. Data source(s) 530 may include EMR, radiology, laboratory and/or other clinical data sources, for example. Data query source(s) 540 may include clinicians, administrators, insurers, pharmacies, prescription benefit managers, and/or other services, for example. The components of the health information architecture 500 may be implemented individually and/or in various combinations in software, hardware and/or firmware, for example.

In operation, document sharing may be facilitated by the architecture 500 via the hub 510. Patient data is passed from one or more sources 520 using an interface standard, such as HL7 and DICOM and the like. Data enters the hub 510 via the gateway/interface 514. Within the hub 510, a message passing interface (MPI), including a patient identifier cross-reference (PIX) and/or a patient demographic query (PDQ) may help facilitate exchanging of relevant patient data, for example. Documents may be stored in the EMR shared clinical repository 516, for example.

One or more query sources 540 may transmit query information to the query engine 512 using an interface standard, such as the X.12 and/or NCPDP communication standard. An electronic prescribing service, such as RxHub, may be used to interface different query sources 540, for example. The query engine 512 serves as a message hub and/or switch to route query messages within the hub 510.

Information from the EMR shared clinical repository 516 may be exchanged with a community of one or more physician or other healthcare office systems, such as an ASP-based office system 560. Alternatively and/or in addition, data may be exchanged with one or more EMRs 470 (e.g., primary care provider EMRs) via one or more Web viewers 550 via a Web viewing application server 520, for example.

In certain embodiments, the hub 510 provides security services during transmission and querying of data. Security services may include generation and storage of audit records, such as audit trail and node authentication (ATNA) accountability records. Additionally, security services may include patient privacy consent management, such as basic patient privacy consent (BPPC). Security services may also include coordination or consistency of time (CT) across network systems.

As discussed above with respect to FIG. 4, access to data may be authenticated and controlled based on one or more rules, profiles, etc. For example, if a healthcare professional requests a patient's documents via the hub 510, the professional first authenticates him or herself to the hub 510. When a security context is established for the user, information about the security context is provided throughout the hub 510. The user queries the XDS registry and/or other data/document organization structure for desired data. The requested document(s) are selected from the repository 516. Based on the authenticated security context for the user and patient consent attribute(s) associated with the selected document(s), the user's right to access the document(s) is determined. If the user is authorized, then the document(s) are transmitted for viewing by the user.

Using the hub 510, a trigger event and/or query function from the query engine 512 may be used to fetch and/or pre-fetch data from the shared clinical repository 516 and/or other data storage, such as an XDS document repository, for example, for transmission to an ASP 560 and/or Web portal 550, for example. In certain embodiments, PIX and/or PDQ information may be used along with query information to fetch information for transmission to a community in authorized communication with the hub 510.

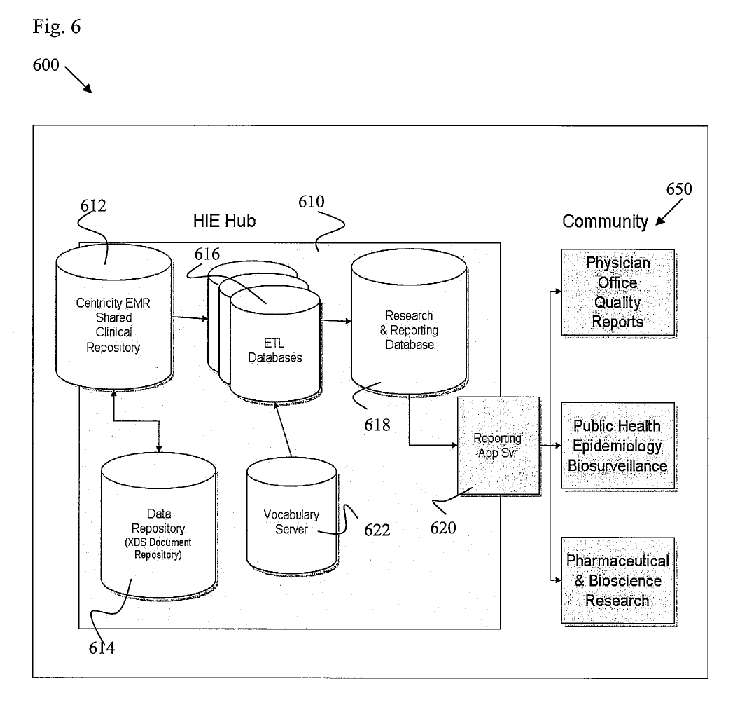

FIG. 6 illustrates a population reporting and research architecture 600 in accordance with an embodiment of the present invention. The architecture 600 includes an HIE hub 610 and a community of reports 650. The hub 610 includes a plurality of data storage, such as an EMR shared clinical repository 612, a data repository 614 (e.g., an XDS document repository), one or more extract, transform and load (ETL) databases 616 and a research and reporting database 618. The hub 610 also includes a reporting application server 620 and a vocabulary server 622. The components of the population reporting and research architecture 600 may be implemented individually and/or in various combinations in software, hardware and/or firmware, for example.

In certain embodiments, the one or more ETL databases 616 extract data from outside source(s), such as repositories 612 and 614, transform the extracted data to fit a format and/or supplied criterion and then load the data into the research and reporting database 618. The vocabulary server 622 is used by the ETL database(s) 616 to transform extracted data. The reporting server 620 receives data from the research and reporting database 618 and transmits that data to the community 650. For example, data output from the reporting application server 620 may include physician office quality reports, public health epidemiology biosurveillance reports, pharmaceutical and bioscience research reports, etc. In response to a query, for example, relevant data may be extracted from one or more repositories 612, 614, formatted appropriately by the ETL database 616 and vocabulary server 622 and stored in the research and reporting database 618. The appropriate data in the research and reporting database 618 is then used by the reporting application server 620 to generate one or more reports for transmission. Report data may be viewed, stored and/or otherwise used by a variety of entities, such as EMRs, practice management and/or information systems, ASP-based systems, etc.

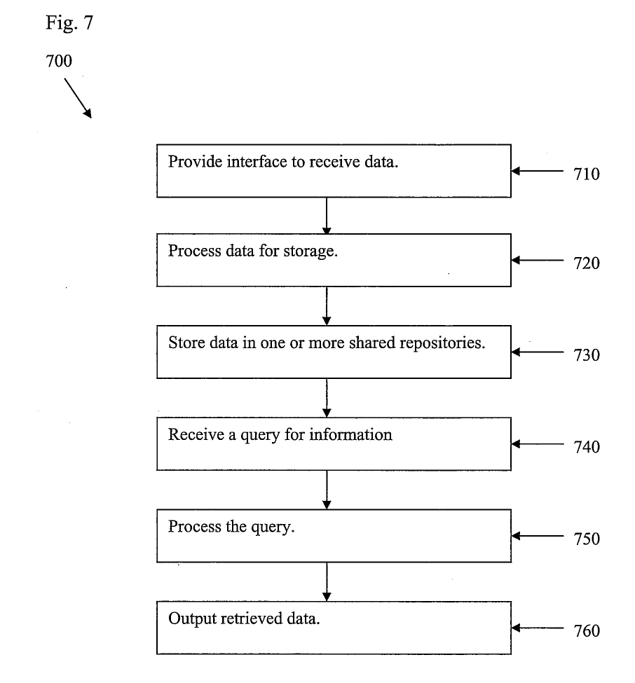

FIG. 7 illustrates a flow diagram for a method 700 for providing health information exchange services in accordance with an embodiment of the present invention. At step 710, an interface is provided to allow a plurality of data sources to transmit data to one or more shared repositories for storage. At step 720, if applicable, data is processed for storage. For example, data may be formatted, normalized, scrubbed, etc. for storage in a shared data repository. At step 730, data is stored in one or more shared repositories, such as an EMR clinical repository, an XDS document repository, etc.

At step 740, a query for information is received at a query engine. At step 750, the query is processed. For example, a pre-fetching of data and/or other query function may be triggered to locate and retrieve requested data from one or more repositories. At step 760, retrieved data is output. For example, retrieved data may be formatted for display (e.g., Web-based viewing), transmission to a local EMR, output to an ASP-provided office system, etc.

One or more of the steps of the method 700 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

In certain embodiments, fees may be charged for one or more of the steps described above. For example, a fee may be charged to allow a user to store data in a shared repository. A fee may be charged to process a query in the health information exchange system, for example. Alternatively and/or in addition, a fee may be charged for a Web viewing application to allow access to and/or manipulation of data output from a repository, for example.

Thus, certain embodiments provide an architecture that includes individually valuable components in a package that is financially sustainable as well as clinically useful. Certain embodiments provide the use of EMR application services to generate revenue streams for a RHIO and/or other healthcare organization. Additionally, an ASP EMR provides a revenue stream as well as having the advantage of providing pre-established data connectivity on the back end for both import and export purposes.

Certain embodiments enable use of population-based data to create revenue streams for a healthcare organization, such as an RHIO. An EMR-based MQIC data warehouse has a special value for RHIOs seeking to aggregate and compare regional data against national benchmarks. Certain embodiments provide use of population data from a RHIO and/or other enterprise for clinical quality and outcomes reporting. Certain embodiments facilitate use of population data from a RHIO and/or other source to create clinical performance metrics at the physician, clinic, enterprise, and regional levels. This approach combined with the other approaches makes this a unique model. Certain embodiments combine MQIC, EMR and connectivity to provide access to claims history data, either raw or filtered through quality and decision support tools, to help physicians enhance performance.

In certain embodiments, population data from a RHIO and/or other shared organization can be used to created clinical performance benchmarks. Population data may also be use to create data sets for pharmacotherapy studies, pharmaceutical outcomes research, pharmacoeconomic research, pharmacoepidemiology, pharmacovigilance, etc. Population data may also be collected from a RHIO and/or other information collection to create data sets for clinical outcomes research, health economic research, clinical epidemiology, and biosurveillance.

Certain embodiments allow use of re-identified individual patient data from a health information organization to inform chronic disease care management, preventive care, and multi-site care coordination, for example. EMR database information may be used to aggregate, scrub, structure, and/or transform raw clinical data from a RHIO, for example, and load a population data warehouse. Data warehouse ETL routines may provide de-identification and re-identification capabilities safeguard patient privacy. Data warehouse ETL routines may also provide medication data processing capabilities to create structured and quantitative medication information for each patient prescription, for example. Certain embodiments provide a quality and outcomes reporting portal based on population data from a health information organization to allow access to clinical performance metrics, benchmarks, and statistics, for example.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing computer processor, or by a special purpose computer processor incorporated for this or another purpose or by a hardwired system.

As noted above, embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represents examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated machine-readable media provide nonvolatile storage of machine-executable instructions, data structures, program modules and other data for the computer.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

1. A health information exchange system, said system comprising:
an interface accommodating a plurality of data sources transmitting data for storage at said health information exchange system;
a shared data repository configured to aggregate and store patient-related data from said plurality of data sources, said shared data repository accessible to a community of users via said health information exchange system;
a query engine for querying said shared data repository to retrieve a subset of patient-related data; and
a Web-based portal providing an authorized user access to said subset of patient-related data for at least one of patient care and clinical performance.

2. The system of claim 1, wherein said health information exchange system facilitates at least one of storing data at said shared data repository and accessing said data via said Web-based portal.

3. The system of claim 1, wherein said shared data repository comprises a shared electronic medical record data repository.

4. The system of claim 1, wherein said health information exchange system provides data to an authorized user via an application service provider.

5. The system of claim 1, wherein said shared data repository comprises a cross document sharing data repository.

6. The system of claim 1 further comprising security services providing protection of patient privacy within said health information exchange system.

7. The system of claim 1, wherein said health information exchange system comprises infrastructure of or for a regional health information organization (“RHIO”).

8. The system of claim 1, wherein said query engine pre-fetches data from said shared data repository in response to a query request.

9. The system of claim 1, wherein said health information exchange system processes data based on at least one of a patient identifier cross-reference and a patient demographic query.

10. The system of claim 1, wherein said shared data repository comprises an extract, transform and load (“ETL”) database in communication with a vocabulary server to transform extracted data.

11. The system of claim 1, wherein data is aggregated and scrubbed in said shared data repository.

12. The system of claim 1, wherein said shared data repository comprises an electronic medical record-based medical quality improvement consortium data warehouse.

13. A method for providing health information exchange services, said method comprising:
providing, for a fee, an interface allowing a plurality of data sources to transmit data to one or more shared data repositories accessible to participants in a health information exchange; and
providing, for a fee, population data from said one or more shared data repositories based on a query.

14. The method of claim 13, wherein said population data is provided via an electronic medical record application service provider.

15. The method of claim 13, further comprising aggregating population data for a region from said one or more shared data repositories for comparison against a national benchmark.

16. The method of claim 13, wherein said providing step further comprises providing, via a Web-based portal, for a fee, population data from said one or more shared data repositories.

17. The method of claim 13, further comprising aggregating, scrubbing, structuring and transforming raw clinical data from a health information exchange to load a population data warehouse.

18. A health information exchange, said exchange comprising:
pre-established data connectivity for import and export of patient data to be shared for a region;
an electronic medical record database configured to aggregate, scrub, structure and transform raw clinical data for said region; and
a population data warehouse loaded with data from said electronic medical record database for data extraction for clinical quality and clinical outcomes reporting.

19. The health information exchange of claim 18, wherein said population data warehouse is configured to safeguard patient privacy.

20. The health information exchange of claim 18, further comprising a viewing application for creating clinical performance metrics and clinical outcomes data sets.
